(19) United States
(12) Patent Application Publication
(10) Pub. No.: US 2014/0043445 A1
(43) Pub. Date: Feb. 13, 2014

(54) METHOD AND SYSTEM FOR CAPTURING A STEREOSCOPIC IMAGE

(71) Applicant: Buyue Zhang, Plano, CA (US)

(72) Inventor: Buyue Zhang, Plano, CA (US)

(21) Appl. No.: 13/957,951

(22) Filed: Aug. 2, 2013

Related U.S. Application Data
(60) Provisional application No. 61/682,427, filed on Aug. 13, 2012.

(51) Int. Cl. H04N 13/02

(52) U.S. Cl. CPC H04N 13/0242
USPC 348/48

(57) ABSTRACT

At least first, second and third imaging sensors simultaneously capture at least first, second and third images of a scene, respectively. An image pair is selected from among the images. A screen displays the image pair to form the stereoscopic image. The image pair is selected in response to at least one of: a size of the screen; and a distance of a user away from the screen.

### CROSS-REFERENCE TO RELATED APPLICATION

This application claims priority to U.S. Provisional Patent Application Ser. No. 61/682,427, filed Aug. 13, 2012, entitled A NEW CONSUMER 3D CAMERA WITH MULTIPLE STEREO BASELINES FOR BETTER 3D DEPTH EFFECT, naming Buyue Zhang as inventor, which is hereby fully incorporated herein by reference for all purposes.

### BACKGROUND

The disclosures herein relate in general to image processing, and in particular to a method and system for capturing a stereoscopic image.

For capturing a stereoscopic image, a stereoscopic camera includes dual imaging sensors, which are spaced apart from one another, namely: (a) a first imaging sensor for capturing a first image of a view for a human's left eye; and (b) a second imaging sensor for capturing a second image of a view for the human's right eye. By displaying the first and second images on a stereoscopic display screen, the captured image is viewable by the human with three-dimensional (“3D”) effect.

If a handheld consumer device (e.g., battery-powered mobile smartphone) includes a stereoscopic camera and a relatively small stereoscopic display screen, then a spacing (“stereo baseline”) between the imaging sensors is conventionally fixed at less than a spacing between the human's eyes, so that the captured image is viewable (on such device's screen) by the human with comfortable 3D effect from a handheld distance. For example, the HTC EVO 3D mobile camera and the LG OPTIMUS 3D mobile camera have fixed stereo baselines of 3.3 cm and 2.4 cm, respectively. By comparison, the spacing between the human's eyes is approximately 6.5 cm.

Nevertheless, if the stereo baseline is conventionally fixed at less than the spacing between the human's eyes, then relevant objects in the captured image have less disparity relative to one another (“relative disparity”). If relevant objects in the captured image have less relative disparity, then the captured image may be viewable by the human with weaker 3D effect (e.g., insufficient depth), especially if those objects appear in a more distant scene (e.g., live sports event). Moreover, even if the human views the captured image on a larger screen (e.g., widescreen television) from a room distance, the larger screen's magnification increases absolute disparity without necessarily resolving a deficiency in relative disparity.

### SUMMARY

In one example, at least first, second and third imaging sensors simultaneously capture at least first, second and third images of a scene, respectively. An image pair is selected from among the images. A screen displays the image pair to form the stereoscopic image. The image pair is selected in response to at least one of: a size of the screen; and a distance of a user away from the screen.

In another example, from among at least first, second and third imaging sensors of a camera, a sensor pair is selected in response to a distance between the camera and at least one object in the scene. The sensor pair is caused to capture the stereoscopic image of the scene.

In yet another example, first and second imaging sensors are housed integrally with a camera. A distance between the first and second imaging sensors is adjusted in response to a distance between the camera and at least one object in the scene. After adjusting the distance, the first and second imaging sensors are caused to capture the stereoscopic image of the scene.

### BRIEF DESCRIPTION OF THE DRAWINGS

FIG. 1 is a block diagram of an information handling system of the illustrative embodiments.

FIG. 2 is a diagram of a first example variable positioning of imaging sensors of FIG. 1.

FIG. 3 is a diagram of viewing axes of a human's left and right eyes.

FIG. 4 is a diagram of a second example variable positioning of the imaging sensors of FIG. 2.

FIG. 5 is a diagram of a touchscreen of a camera of FIG. 1.

FIG. 6 is a diagram of a third example variable positioning of the imaging sensors of FIG. 2.

FIG. 7 is a diagram of a first example fixed positioning of imaging sensors of FIG. 1.

FIG. 8 is a flowchart of an operation of a display device of FIG. 1, in a first example.

FIG. 9 is a flowchart of an operation of the camera of FIG. 7, in a second example.

FIG. 10 is a diagram of a second example fixed positioning of imaging sensors of FIG. 1.

### DETAILED DESCRIPTION

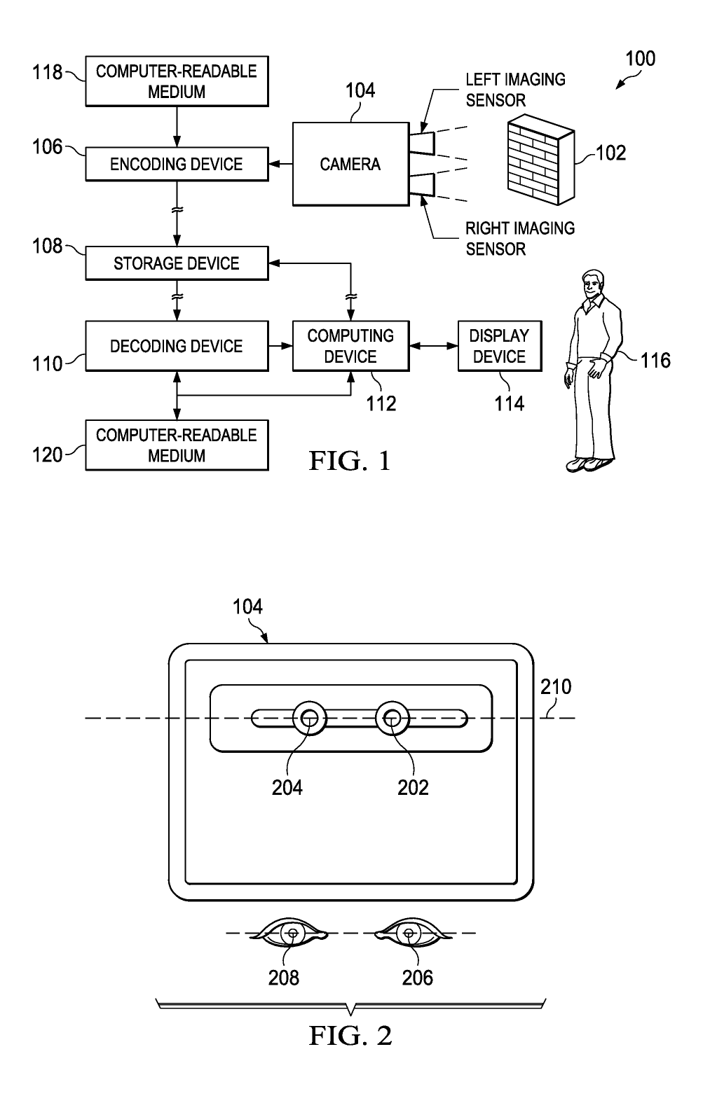

FIG. 1 is a block diagram of an information handling system (e.g., one or more computers and/or other electronics devices, such as battery-powered mobile smartphones), indicated generally at 100, of the illustrative embodiments. In the FIG. 1 example, a scene (e.g., including a physical object 102 and its surrounding foreground and background) is viewed by a camera 104, which: (a) captures and digitizes images of such views; and (b) outputs a video sequence of such digitized (or “digital”) images to an encoding device 106. As shown in FIG. 1, the camera 104 is a stereoscopic camera that includes imaging sensors, which are spaced apart from one another, namely at least: (a) a first imaging sensor for capturing, digitizing and outputting (to the encoding device 106) a first image of a view for a human's left eye; and (b) a second imaging sensor for capturing, digitizing and outputting (to the encoding device 106) a second image of a view for the human's right eye.

The encoding device 106: (a) receives the video sequence from the camera 104; (b) encodes the video sequence into a binary logic bit stream; and (c) outputs the bit stream to a storage device 108, which receives and stores the bit stream. A decoding device 110: (a) reads the bit stream from the storage device 108; (b) in response thereto, decodes the bit stream into the video sequence; and (c) outputs the video sequence to a computing device 112.

The computing device 112: (a) receives the video sequence from the decoding device 110 (e.g., automatically, or in response to a command from a display device 114, such as a command that a user 116 specifies via a touchscreen of the display device 114); and (b) optionally, outputs the video sequence to the display device 114 for display to the user 116. Also, the computing device 112 automatically: (a) performs various operations for detecting objects (e.g., obstacles) and for identifying their respective locations (e.g., estimated coordinates, sizes and orientations) within the video sequence's images, so that results (e.g., locations of detected objects) of such operations are optionally displayable (e.g., within such images) to the user 116 by the display device 114; and (b) writes such results for storage into the storage device 108.

Optionally, the display device 114: (a) receives the video sequence and such results from the computing device 112 (e.g., automatically, or in response to a command that the user 116 specifies via the touchscreen of the display device 114); and (b) in response thereto, displays the video sequence (e.g., including stereoscopic images of the object 102 and its surrounding foreground and background) and such results, which are viewable by the user 116 (e.g., with 3D effect). The display device 114 is any display device whose screen is suitable for displaying stereoscopic images, such as a polarized display screen, an active shutter display screen, or an autostereoscopy display screen. In one example, the display device 114 displays a stereoscopic image with three-dimensional (“3D”) effect for viewing by the user 116 through special glasses that: (a) filter the first image against being seen by the right eye of the user 116; and (b) filter the second image against being seen by the left eye of the user 116. In another example, the display device 114 displays the stereoscopic image with 3D effect for viewing by the user 116 without relying on special glasses.

The encoding device 106 performs its operations in response to instructions of computer-readable programs, which are stored on a computer-readable medium 118 (e.g., hard disk drive, nonvolatile flash memory card, and/or other storage device). Also, the computer-readable medium 118 stores a database of information for operations of the encoding device 106. Similarly, the decoding device 110 and the computing device 112 perform their operations in response to instructions of computer-readable programs, which are stored on a computer-readable medium 120. Also, the computer-readable medium 120 stores a database of information for operations of the decoding device 110 and the computing device 112.

The system 100 includes various electronic circuitry components for performing the system 100 operations, implemented in a suitable combination of software, firmware and hardware, such as one or more digital signal processors (“DSPs”), microprocessors, discrete logic devices, application specific integrated circuits (“ASICs”), and field-programmable gate arrays (“FPGAs”). In one embodiment: (a) a first electronics device includes the camera 104, the encoding device 106, and the computer-readable medium 118, which are housed integrally with one another; and (b) a second electronics device includes the decoding device 110, the computing device 112, the display device 114 and the computer-readable medium 120, which are housed integrally with one another.

In an alternative embodiment: (a) the encoding device 106 outputs the bit stream directly to the decoding device 110 via a network, such as a mobile (e.g., cellular) telephone network, a landline telephone network, and/or a computer network (e.g., Ethernet, Internet or intranet); and (b) accordingly, the decoding device 110 receives and processes the bit stream directly from the encoding device 106 substantially in real-time. In such alternative embodiment, the storage device 108 either: (a) concurrently receives (in parallel with the decoding device 110) and stores the bit stream from the encoding device 106; or (b) is absent from the system 100.

FIG. 2 is a diagram of a first example variable positioning of imaging sensors 202 and 204 (housed integrally with the camera 104), in which a line between the sensors 202 and 204 is substantially parallel to a line between eyes 206 and 208 of the user 116. As shown in the FIG. 2 example, the stereo baseline (spacing between the sensors 202 and 204) is initially less than a spacing between the eyes 206 and 208. Nevertheless, in the FIG. 2 example, the camera 104 includes a mechanical structure (e.g., gears) for the user 116 to operate by sliding (e.g., manually) one or both of the sensors 202 and 204 in the same or opposite directions along a dashed line 210, so that the stereo baseline is thereby adjusted.

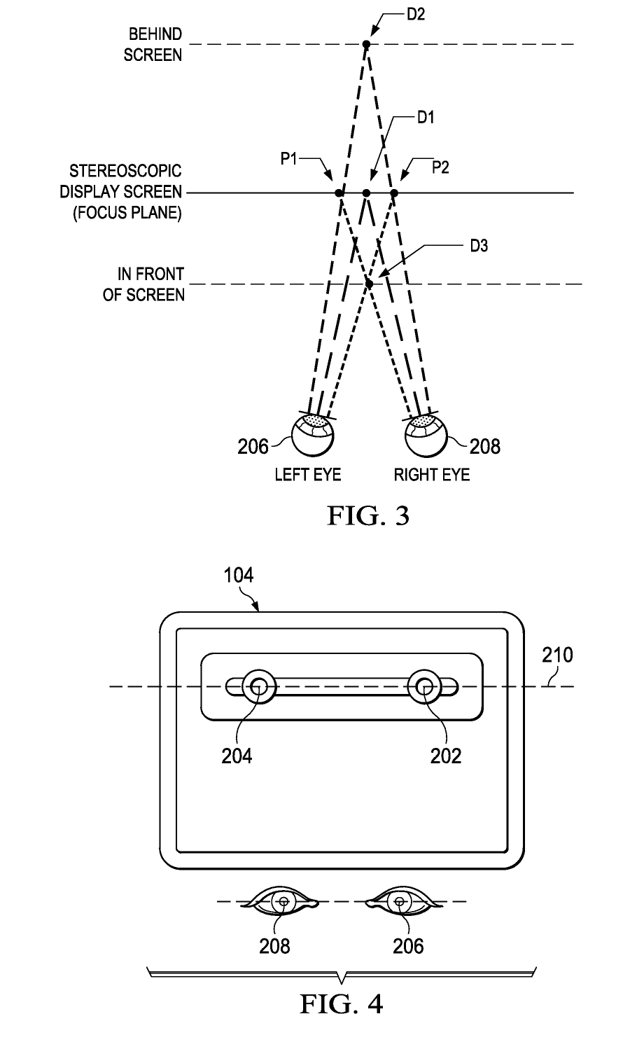

FIG. 3 is a diagram of viewing axes of the eyes 206 and 208. In the FIG. 3 example, a stereoscopic image is displayable by the display device 114 on a stereoscopic display screen, which is a plane where the eyes 206 and 208 focus (“focus plane”). The user 116 views the stereoscopic image on the display device 114 and experiences the 3D effect by converging the eyes 206 and 208 on a feature (e.g., virtual object) in the stereoscopic image, which can appear on the focus plane (e.g., at a point D1), behind the screen (e.g., at a point D2), and/or in front of the screen (e.g., at a point D3).

Within the stereoscopic image, a feature's disparity is a horizontal shift between: (a) such feature's location within the first image; and (b) such feature's corresponding location within the second image. A limit of such disparity is dependent on the camera 104. For example, if a feature (within the stereoscopic image) is centered at the point D1 within the first image, and likewise centered at the point D1 within the second image, then: (a) such feature's disparity =D1−D1=0; and (b) the user 116 will perceive the feature to appear at the point D1 on the screen, which is most comfortable for the user 116 to avoid conflict between focus and convergence.

By comparison, if the feature is centered at a point P1 within the first image, and centered at a point P2 within the second image, then: (a) such feature's disparity =P2−P1 will be positive; and (b) the user 116 will perceive the feature to appear at the point D2 behind the screen. Conversely, if the feature is centered at the point P2 within the first image, and centered at the point P1 within the second image, then: (a) such feature's disparity =P1−P2 will be negative; and (b) the user 116 will perceive the feature to appear at the point D3 in front of the screen. The amount of the feature's disparity (e.g., horizontal shift of the feature from P1 within the first image to P2 within the second image) is measurable as a number of pixels, so that: (a) positive disparity is represented as a positive number; and (b) negative disparity is represented as a negative number.

The 3D effect is stronger if relevant objects in the scene have more disparity relative to one another (“relative disparity”), instead of relying upon absolute disparity. For example, if all objects in the scene have a similar disparity, then the 3D effect is weaker. Camera depth effect (“CDE”) measures the camera's 3D effect as CDE=MC*CRC, where: (a) MC is the camera's lateral magnification, which is computed by dividing its horizontal sensor size by its horizontal field-of-view (“FOV”); and (b) CRC is the camera's “convergence ratio,” which is computed by dividing its stereo baseline by its convergence distance. Accordingly, the CDE is proportional to the CRC, yet inversely proportional to: (a) the camera's horizontal FOV; and (b) its convergence distance.

FIG. 4 is a diagram of a second example variable positioning of the imaging sensors 202 and 204, in which the user 116 has operated the mechanical structure of the camera 104 by sliding both of the sensors 202 and 204 in opposite directions along the dashed line 210, so that the stereo baseline is thereby adjusted relative to the FIG. 2 example. As shown in the FIG. 4 example, the adjusted stereo baseline is greater than the spacing between the eyes 206 and 208, so that: (a) the camera 104 is suitable for capturing images of distant scenes (e.g., live sports events); and (b) those captured images are suitable for viewing on a larger screen (e.g., 60″ widescreen television) from a room distance (e.g., 9 feet). Accordingly, in the examples of FIGS. 2 and 4, the stereo baseline of the camera 104 is continuously variable within a physical range of the mechanical structure's motion.

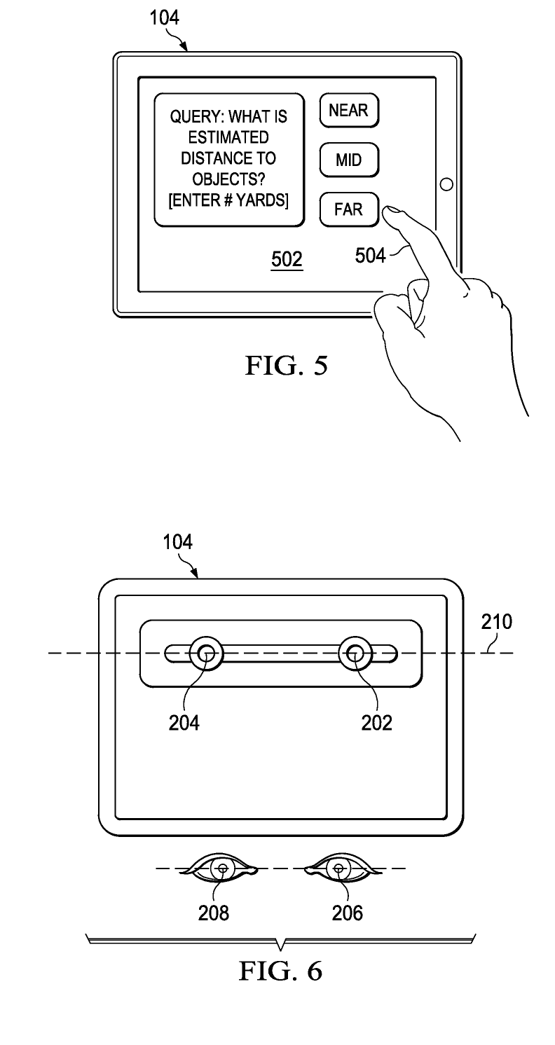

FIG. 5 is a diagram of a touchscreen 502 of the camera 104, such as: (a) a liquid crystal display (“LCD”) device; and (b) touch-sensitive circuitry of such LCD device, so that the touch-sensitive circuitry is integral with such LCD device. Accordingly, the user 116 operates the touchscreen 502 (e.g., virtual keys thereof, such as a virtual keyboard and/or virtual keypad) for specifying information (e.g., alphanumeric text information) and other commands to a central processing unit (“CPU”) of the camera 104, which receives such information and commands from the touchscreen 502. In this example, the sensors 202 and 204 are located on a bottom side of the camera 104, and the touchscreen 502 is located on a front side of the camera 104.

The touchscreen 502: (a) detects presence and location of a physical touch (e.g., by a finger 504 of the user 116, and/or by a passive stylus object) within a display area of the touchscreen 502; and (b) in response thereto, outputs signals (indicative of such detected presence and location) to the CPU. In that manner, the user 116 can physically touch (e.g., single tap, double tap, and/or press-and-hold) the touchscreen 502 to: (a) select a portion (e.g., region) of a visual image that is then-currently displayed by the touchscreen 502; and/or (b) cause the touchscreen 502 to output various information to the CPU. Accordingly: (a) the CPU executes a computer-readable software program; (b) such program is stored on a computer-readable medium of the camera 104; and (c) in response to instructions of such program, and in response to such physical touch, the CPU causes the touchscreen 502 to display various screens.

Optionally, in response to the CPU receiving (from the user 116 via the touchscreen 502) a command for the camera 104 to capture a stereoscopic image, the CPU causes the touchscreen 502 to display a “near” button, a “mid” button, a “far” button, and a “query” button. In response to the user 116 physically touching the “near” button on the touchscreen 502, the CPU causes an actuator of the camera 104 to automatically slide the sensors 202 and 204 (e.g., instead of the user 116 manually sliding the sensors 202 and 204) for adjusting the stereo baseline to the first example variable positioning as shown in FIG. 2, so that: (a) the camera 104 is suitable for capturing images of near scenes; and (b) those captured images are suitable for viewing on a smaller screen (e.g., the touchscreen 502 itself) from a handheld distance. Conversely, in response to the user 116 physically touching the “far” button on the touchscreen 502, the CPU causes the actuator of the camera 104 to automatically slide the sensors 202 and 204 for adjusting the stereo baseline to the second example variable positioning as shown in FIG. 4.

By comparison, in response to the user 116 physically touching the “mid” button on the touchscreen 502, the CPU causes the actuator of the camera 104 to automatically slide the sensors 202 and 204 for adjusting the stereo baseline to a third example variable positioning (approximately midway between the first and second example variable positionings) as shown in FIG. 6. As shown in the FIG. 6 example, the adjusted stereo baseline is approximately equal to the spacing between the eyes 206 and 208, so that: (a) the camera 104 is suitable for capturing images of midrange scenes (between near scenes and distant scenes); and (b) those captured images are suitable for viewing on a midsize screen (e.g., desktop computer screen) from an intermediate distance (between handheld distance and room distance).

In response to the user 116 physically touching the “query” button (FIG. 5) on the touchscreen 502, the CPU: (a) causes the touchscreen 502 to query the user 116 about an estimated distance (e.g., number of yards) between the camera 104 and relevant objects in the scene; (b) receives (from the user 116 via the touchscreen 502) an answer to such query; (c) in response to such answer, computes (e.g., by performing a table look-up operation) a positioning that is suitable for capturing images of the scene, according to the estimated distance between the camera 104 and relevant objects in the scene; and (d) causes the actuator of the camera 104 to automatically slide the sensors 202 and 204 for adjusting the stereo baseline to the computed positioning.

In the examples of FIGS. 2, 4 and 6, for the stereo baseline of the camera 104 to be continuously variable (within a physical range of the mechanical structure's motion), the mechanical structure: (a) adds cost to the camera 104; and (b) introduces risk of misalignment between the sensors, because their positioning is variable.

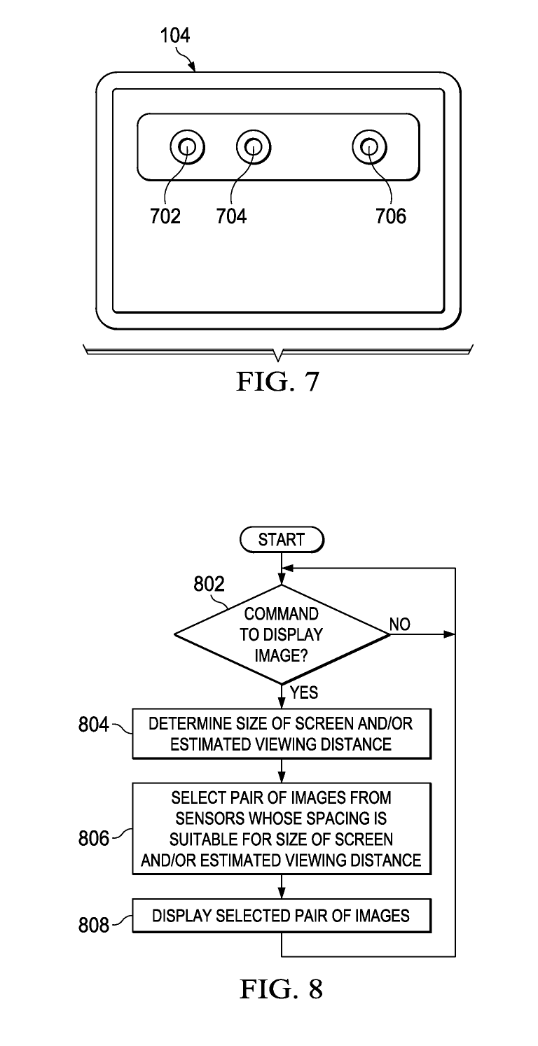

FIG. 7 is a diagram of a first example fixed positioning of imaging sensors 702, 704 and 706 (of the camera 104). In comparison to the FIGS. 2, 4 and 6 examples, the FIG. 7 example: (a) adds less cost to the camera 104; and (b) avoids risk of misalignment between the sensors, because their positioning is fixed. Although their positioning is fixed, the sensors 702, 704 and 706 achieve three (3) different stereo baselines, which is advantageous in comparison to a different stereoscopic camera that has a fixed positioning of only two (2) sensors and one (1) stereo baseline.

Spacing between the sensors 702 and 704 is k1*IPD, where k1 is a first positive number, and IPD is the spacing between the eyes 206 and 208. Spacing between the sensors 704 and 706 is k2*IPD, where k2 is a second positive number. Accordingly, the sensors 702, 704 and 706 achieve three (3) different stereo baselines, namely: (a) k1*IPD; (b) k2*IPD; and (c) (k1+k2)*IPD. For example, if k1=0.5 and k2=1, then the three stereo baselines are 0.5*IPD, 1.0*IPD, and 1.5*IPD. With the three stereo baselines, respectively: (a) the camera 104 is suitable for capturing images of near scenes, midrange scenes and distant scenes; and (b) those captured images are suitable for viewing on a smaller screen from a handheld distance, a midsize screen from an intermediate distance, and a larger screen from a room distance.

FIG. 8 is a flowchart of an operation of a display device (e.g., the display device 114 or the touchscreen 502) of the system 100, in a first example. Referring to FIG. 7, in response to the CPU of the camera 104 receiving (from the user 116 via the touchscreen 502) a command for the camera 104 to capture a stereoscopic image, the sensors 702, 704 and 706 simultaneously capture, digitize and output (to the encoding device 106) first, second and third images, respectively. Referring to FIG. 8, at a step 802, the operation self-loops until the display device receives a command to display the captured stereoscopic image.

At a next step 804, the display device determines a size of its screen and/or an estimated viewing distance of the user 116 away from that screen. In one example, the size of its screen and the estimated viewing distance are constants, so the display device is able to skip the step 804 in such example. At a next step 806, the display device selects a pair (“selected image pair”) of the first, second and third images that were received from a pair of the sensors 702, 704 and 706 whose spacing is suitable for the size of its screen and the estimated viewing distance.

At a next step 808, the display device displays the selected image pair, and the operation returns to the step 802. For viewing on a smaller screen from a handheld distance, the captured first and second images are displayed on the smaller screen to form the stereoscopic image. For viewing on a midsize screen from an intermediate distance, the captured second and third images are displayed on the midsize screen to form the stereoscopic image. For viewing on a larger screen from a room distance, the captured first and third images are displayed on the larger screen to form the stereoscopic image.

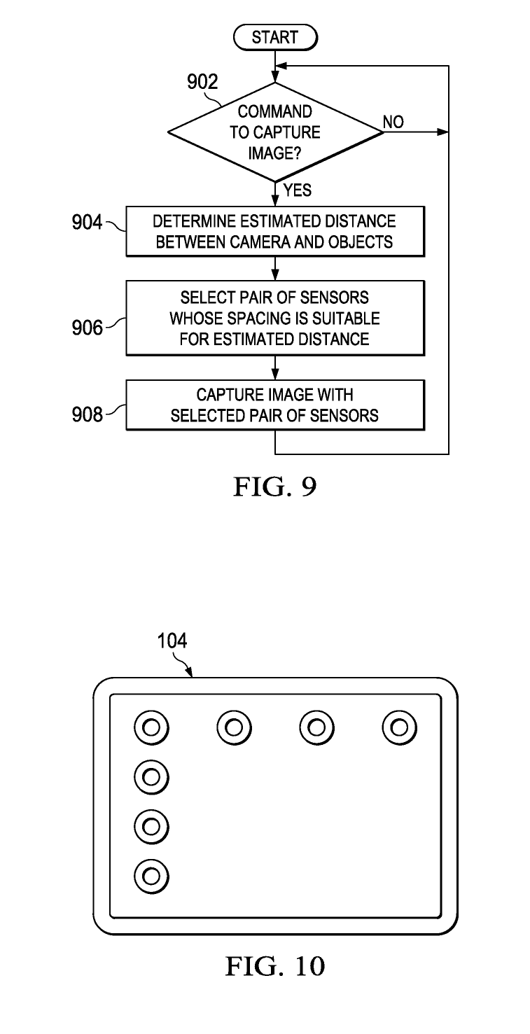

FIG. 9 is a flowchart of an operation of the camera 104 of FIG. 7, in a second example. At a step 902, the operation self-loops until the CPU of the camera 104 receives (from the user 116 via the touchscreen 502) a command for the camera 104 to capture a stereoscopic image. At a next step 904, the CPU determines an estimated distance (e.g., number of yards) between the camera 104 and relevant objects in the scene. At a next step 906, the CPU selects a pair (“selected sensor pair”) of the sensors 702, 704 and 706 whose spacing is suitable for the estimated distance. At a next step 908, the CPU causes only the selected sensor pair to simultaneously capture, digitize and output (to the encoding device 106) first and second images that together form the stereoscopic image.

In one version of the steps 904, 906 and 908, the CPU causes the touchscreen 502 to display the “near” button, the “mid” button, the “far” button, and the “query” button (FIG. 5). In response to the user 116 physically touching the “near” button on the touchscreen 502, the CPU causes only the sensors 702 and 704 to simultaneously capture, digitize and output (to the encoding device 106) first and second images that together form the stereoscopic image. In response to the user 116 physically touching the “mid” button on the touchscreen 502, the CPU causes only the sensors 704 and 706 to simultaneously capture, digitize and output (to the encoding device 106) first and second images that together form the stereoscopic image. In response to the user 116 physically touching the “far” button on the touchscreen 502, the CPU causes only the sensors 702 and 706 to simultaneously capture, digitize and output (to the encoding device 106) first and second images that together form the stereoscopic image.

In response to the user 116 physically touching the “query” button (FIG. 5) on the touchscreen 502, the CPU: (a) causes the touchscreen 502 to query the user 116 about the estimated distance between the camera 104 and relevant objects in the scene; (b) receives (from the user 116 via the touchscreen 502) an answer to such query; (c) in response to such answer, computes (e.g., by performing a table look-up operation) a stereo baseline that is suitable for capturing images of the scene, according to the estimated distance between the camera 104 and relevant objects in the scene; (d) selects two of the sensors 702, 704 and 706 whose spacing is closest to the computed stereo baseline; and (e) causes only those selected two sensors to simultaneously capture, digitize and output (to the encoding device 106) first and second images that together form the stereoscopic image.

FIG. 10 is a diagram of a second example fixed positioning of imaging sensors (of the camera 104). The FIG. 10 example operates in the same manner as the FIG. 7 example, but the FIG. 10 example: (a) achieves more different stereo baselines; (b) positions the sensors along a first line and a second line (orthogonal to the first line) for the user 116 to intuitively view (e.g., on the touchscreen 502) scenes with different aspect ratios (e.g., landscape and portrait); and (c) adds cost to the camera 104. For example, with a line of N sensors that are equally spaced apart from one another by a distance T, a combination of (N−1) different stereo baselines are achieved. In FIG. 10: (a) the first line of N=4 sensors are equally spaced apart from one another by a distance T₁, thereby achieving a first combination of different stereo baselines, namely T₁, 2*T₁ and 3*T₁ (suitable for capturing stereoscopic images in a first orientation); and (b) the second line of N=4 sensors are equally spaced apart from one another by a distance T₂, thereby achieving a second combination of different stereo baselines, namely T₂, 2^{*}T₂ and 3*T₂ (suitable for capturing stereoscopic images in a second orientation, orthogonal to the first orientation).

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A system for capturing a stereoscopic image, the system comprising:
at least first, second and third imaging sensors for simultaneously capturing at least first, second and third images of a scene, respectively;
circuitry for selecting an image pair from among the images; and
a screen for displaying the image pair to form the stereoscopic image;
wherein selecting the image pair includes selecting the image pair in response to at least one of: a size of the screen; and a distance of a user away from the screen.

2. The system of claim 1, wherein a spacing between the first and second imaging sensors is less than a spacing between the second and third imaging sensors.

3. A system for capturing a stereoscopic image, the system comprising:
at least first, second and third imaging sensors of a camera for simultaneously capturing at least first, second and third images of a scene, respectively; and
circuitry for: selecting a sensor pair from among the imaging sensors in response to a distance between the camera and at least one object in the scene; and causing the sensor pair to capture the stereoscopic image of the scene.

4. The system of claim 3, wherein the circuitry is for: from a user, receiving an estimate of the distance.

5. The system of claim 4, and comprising:
a touchscreen of the camera for receiving the estimate from the user.

6. The system of claim 3, wherein a spacing between the first and second imaging sensors is less than a spacing between the second and third imaging sensors.

7. A system for capturing a stereoscopic image, the system comprising:
first and second imaging sensors of a camera for simultaneously capturing at least first and second images of a scene, respectively, wherein the first and second imaging sensors are housed integrally with the camera; and
at least one device for: adjusting a distance between the first and second imaging sensors in response to a distance between the camera and at least one object in the scene; and, after adjusting the distance, causing the first and second imaging sensors to capture the stereoscopic image of the scene.

8. The system of claim 7, wherein the device is for: from a user, receiving an estimate of the distance.

9. The system of claim 8, and comprising:
a touchscreen of the camera for receiving the estimate from the user.

10. The system of claim 7, wherein adjusting the distance includes adjusting the distance manually.

11. The system of claim 7, wherein adjusting the distance includes adjusting the distance automatically.

12. The system of claim 7, wherein adjusting the distance includes adjusting the distance in a continuously variable manner within a physical range of motion of a mechanical structure of the first and second imaging sensors.

13. A method of capturing a stereoscopic image, the method comprising:
with at least first, second and third imaging sensors, simultaneously capturing at least first, second and third images of a scene, respectively;
selecting an image pair from among the images in response to at least one of: a size of a screen; and a distance of a user away from the screen; and
on the screen, displaying the image pair to form the stereoscopic image.

14. The method of claim 13, wherein a spacing between the first and second imaging sensors is less than a spacing between the second and third imaging sensors.

15. A method of capturing a stereoscopic image, the method comprising:
from among at least first, second and third imaging sensors of a camera, selecting a sensor pair in response to a distance between the camera and at least one object in a scene; and
causing the sensor pair to capture the stereoscopic image of the scene.

16. The method of claim 15, and comprising:
from a user, receiving an estimate of the distance.

17. The method of claim 16, wherein receiving the estimate includes:
receiving the estimate from the user via a touchscreen of the camera.

18. The method of claim 15, wherein a spacing between the first and second imaging sensors is less than a spacing between the second and third imaging sensors.

19. A method of capturing a stereoscopic image, the method comprising:
adjusting a distance between first and second imaging sensors of a camera in response to a distance between the camera and at least one object in a scene, wherein the first and second imaging sensors are housed integrally with the camera; and
after adjusting the distance, causing the first and second imaging sensors to capture the stereoscopic image of the scene.

20. The method of claim 19, and comprising:
from a user, receiving an estimate of the distance.

21. The method of claim 20, wherein receiving the estimate includes:
receiving the estimate from the user via a touchscreen of the camera.

22. The method of claim 19, wherein adjusting the distance includes adjusting the distance manually.

23. The method of claim 19, wherein adjusting the distance includes adjusting the distance automatically.

24. The method of claim 19, wherein adjusting the distance includes adjusting the distance in a continuously variable manner within a physical range of motion of a mechanical structure of the first and second imaging sensors.
